(19) United States
(12) Patent Application Publication
(10) Pub. No.: US 2007/0006693 A1
(43) Pub. Date: Jan. 11, 2007

(54) BRACKET

(75) Inventor: Ya-Chyi Chou, Taipei (TW)

Correspondence Address: THE LAW OFFICES OF MIKIO ISHIMARU, 333 W. EL CAMINO REAL, SUITE 330, SUNNYVALE, CA, 94087, US

(73) Assignee: INVENTEC MULTIMEDIA & TELECOM CORPORATION, Taipei (TW)

(21) Appl. No.: 11/428,276

(22) Filed: Jun. 30, 2006

(30) Foreign Application Priority Data
Jul. 5, 2005 (TW) 094211308

(51) Int. Cl. B25G 1/00

(52) U.S. Cl. 81/492

(57) ABSTRACT

A bracket for supporting an electronic product includes at least a first supporting member and a second supporting member connected with and formed at an included angle with the first supporting member. The first supporting member has at least one first positional portion and the second supporting member has at least one second positional portion. The length of the second supporting member is larger than the first supporting member such that the bracket may provide various viewing angles for an electronic product by holding the electronic product at a desired angle on a plane surface by flexibly positioning the one or more first positional portions and the one or more second positional portions with respect to the electronic product.

### FIELD OF THE INVENTION

The present invention relates to a bracket, and more specifically relates to a bracket for supporting an electronic product and providing various viewing angles thereto.

### BACKGROUND OF THE INVENTION

Electronic products equipped with various functions are widely used in daily life. Since people often need to use such products for long periods of time, the human-machine interaction interface for communicating information between such electronic products and users has become particularly important.

During the operation an electronic product, an inappropriate human-machine interaction interface may easily fatigue the user and lead to particular pathological conditions of the human body associated with prolonged use of stress-inducing equipment. Conversely, a human-machine interaction interface that conforms with human engineering factors can provide comfortable operation for the user and avoid or alleviate weariness resulting from use of an electronic product over a long period of time.

As such, for an electronic product having a viewable interface, the viewing angle of the visible interface is one of the important factors in terms of the comfort level of the human-machine interaction interface.

However, present electronic products such as an IP telephone typically only provide the user a vary limited viewing angle of operation, such as the fixed viewing angle associated with hanging on the wall or placing on a plane surface (e.g. a table). Such an electronic product placed on a plane surface can only provide one primary viewing angle, but the comfort level of use under various conditions will generally not be optimal, so as to result in user-fatigue.

In summary, providing a solution capable of providing various viewing angles by adjusting positioning of an electronic product on a plane surface is therefore a highly desirable objective in terms of user convenience, comfort, and health.

### SUMMARY OF THE INVENTION

In view of the above shortcomings in the conventional technology, a main purpose of the present invention is to provide a bracket for providing various viewing angles for an electronic product.

Another purpose of the present invention is to provide a low-cost bracket.

Yet another purpose of the present invention is to provide a bracket with easy assembly.

Another purpose of the present invention is to provide a durable bracket.

Another purpose of the present invention is to provide a bracket with the feature that wires may be easily concentrated.

To achieve the above objectives and other objectives, the present invention provides a bracket for supporting an electronic product including at least a first supporting member and a second supporting member. The first supporting member has at least one first positional portion. The second supporting member is connected with and formed at an included angle with the first supporting member, the length thereof being larger than the first supporting member and having at least one second positional portions such that the bracket may provide various viewing angles for the electronic product when holding the electronic product at a desired angle on a plane surface by flexibly positioning the one or more first positional portions and the one or more second positional portions with respect to the electronic product.

Preferably, the bracket is composed of elastic material, wherein, the elastic material is a material selected from plastics and metals; the bracket has a U-shaped structure; the first supporting member and the second supporting member are part of an integral structure.

Each of the first positional portions has a protruding structure. Wherein, each of the first positional portions has a structure selected from the group consisting of a jut, a bulge, and a lug structure. The included angle between the first supporting member and the second supporting member is an acute angle. Each of the second positional portions has a protruding structure. Each of the second positional portions has a structure selected from a group consisting of a jut, a bulge, and a lug structure. In other words, the structure of each of the first positional portions and that of the second positional portions may be selected to be identical structures.

In a preferred embodiment, each of the first positional portions and each of the second positional portions are provided with symmetrical structures. In another preferred embodiment, each of the first positional portions and each of the second positional portions are provided with asymmetrical structures.

Additionally, the second supporting member is optionally formed with a winding structure at a position closed to the second positional portion.

The bracket may further include at least one opening and a plurality of anti-slip members. The opening is provided between the first supporting member and the second supporting member. The anti-slip members are provided on both sides of the opening, wherein each of the anti-slip members has a structure selected from the group consisting of a rugged structure, a granular structure, and a ladder structure.

Compared to the conventional technology, the bracket of the present invention provides a first supporting member and a second supporting member with different lengths, and the position for placing the first supporting member and the second supporting member with respect to an electronic product can be exchanged. For example, the first supporting member may stay close to the plane surface and rely thereon, and the second supporting member may be held at an incline on the upper end of the electronic product for supporting it; or, oppositely, the second supporting member may stay close to the plane surface and rely thereon, and the first supporting member may be held at an incline on the upper end of the electronic product for supporting it.

Thus, by providing various viewing angles by adjusting placement angles of an electronic product on a plane surface, the invention is able to select different viewing angles for the electronic product with respect to the placement surface, thus solving the shortcoming associated with the conventional technology wherein it could only provide one of viewing angle with placement on a plane surface such that the comfort level of use under various conditions was compromised, resulting in user-fatigue.

Furthermore, the present invention can be manufactured with a simple extruding technology. It is able to provide different viewing angles by a single plastic component, such that a low-cost bracket can be provided. In addition, application of the simple-structured bracket of the present invention allows the electronic product to be held on the placement surface. The structure thus not only has easy assembly but also allows for easily varying the viewing angle. Additionally, the bracket of the present invention is durable due to its U-shaped structure. Moreover, the opening of the present invention can allow wires of the electronic product to pass through, such that the wires may be easily concentrated to enhance aesthetics and provide orderly management.

In summary, the present invention provides different viewing angles for an electronic product while holding it, so as to solve shortcomings of the conventional bracket technology. And since the bracket of the present invention is simple in structure, easy to manufacture, low-cost, durable, easily assembled, and capable of concentrating wires, it is useful and increases the industrial applicability of display-and-support brackets.

The examples of the present invention are illustrated with the following specific embodiments, and a person skilled in the art can easily realize the advantages and effectiveness of the present invention according to the disclosed contents in the specification. The present invention may be executed or applied with other differing embodiments, and details in the specification may be modified or varied based on different points of view and applications without departing from the spirit of the present invention.

### BRIEF DESCRIPTION OF THE DRAWINGS

FIG. 1 is a three-dimensional diagram of a bracket in accordance with the first embodiment of the present invention.

FIG. 2 is a rear-view diagram of the bracket of FIG. 1.

FIG. 3A is a diagram showing the structure of the bracket of FIG. 1 before assembly with an electronic product.

FIG. 3B is a cross-sectional diagram showing the structure of the bracket of FIG. 1 after assembly with an electronic product.

FIG. 3C is a cross-sectional diagram showing another structure of the bracket of FIG. 1 after assembly with an electronic product.

FIG. 4 is a rear-view diagram showing the bracket of the present invention assembled with an electronic product.

FIG. 5 is a diagram of a bracket in accordance with the second embodiment of the present invention, wherein the bracket is not assembled with an electronic product.

### DETAILED DESCRIPTION OF THE PREFERRED EMBODIMENTS

The following examples are provided to further illustrate the present invention, and are by no means used to limit the scope of the present invention.

It should be noted that the bracket of the present invention is illustrated by an exemplified bracket used to support an electronic product such as an IP telephone; however, it should not be limited to this application. Also, since any electronic product can be used without changing in the structure, only the structure directly related to the present invention is shown in the figures and remaining structures are omitted to simplify and further clarify the features and the structure of the present invention.

### Example 1

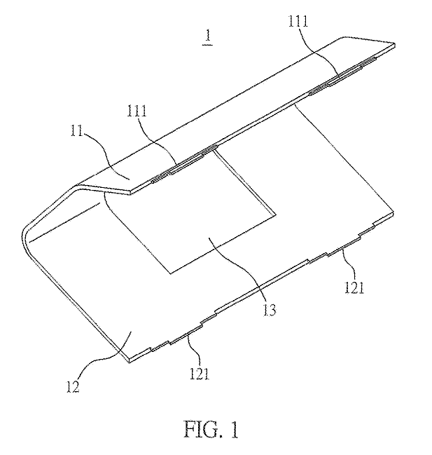

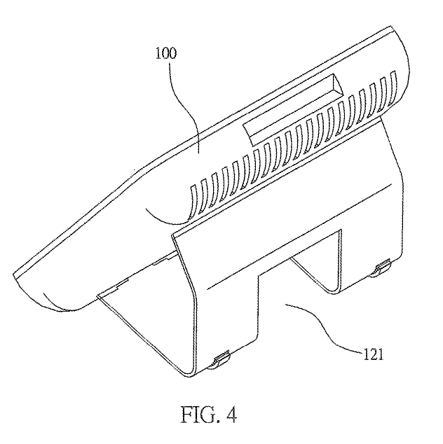

FIGS. 1-4 depict a bracket in accordance with the first embodiment of the present invention. As shown in FIG. 1, the bracket 1 of the embodiment includes a first supporting member 11 and a second supporting member 12.

The first supporting member 11 is provided with at least one first positional portion 111. In the present embodiment, the first supporting member 11 is provided with two first positional portions 111, and each of the first positional portions 111 has a protruding structure such as a lug structure or any other equivalent structure.

The second supporting member 12 is coupled to and forming at an included angle with the first supporting member 11. Additionally, the length of the second supporting member 12 is larger than the first supporting member 11, and the second supporting member 12 has at least one second positional portion 121, wherein, each of the second positional portions 121 has an identical structure with each of the first positional portions 111, which can be a protruding structure such as a lug structure or any other equivalent structure. Furthermore, the second supporting member 12 can form a winding structure at a position closed to the second positional portions 121, such that the second positional portions 121 may positioned to the electronic product more easily (as will be explained later).

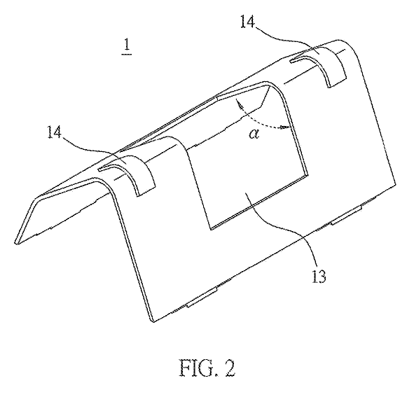

As shown in FIG. 2, the included angle between the second supporting member 12 and the first supporting member 11 is an acute angle; i.e. an included angle that is less than 90 degrees.

Additionally, the bracket 11 of the embodiment can be manufactured with an elastic material such as plastic, and, as such, the second supporting member 12 and the first supporting member 11 can constitute an integral structure. And the second supporting member 12 can form a winding structure at a position closed to the second positional portions 121 to provide a roughly U-shaped structure, thus enabling backward assembly to the electronic product and allowing the second positional portions 121 of the second supporting member 12 to have a longer length, thus positioning to the electronic product more easily. However, the invention is not limited to this particular design.

Furthermore, the bracket 11 of the present invention can further provide at least an opening 13 (as shown in FIG. 1 and FIG. 2) and a plurality of anti-slip members 14 (as shown in FIG. 2). Referring to FIG. 1 and FIG. 2, the opening 13 is provided between the first supporting member 11 and the second supporting member 12. As shown in FIG. 2, anti-slip members 14 are provided on both sides of the opening 13 and can have a structure selected from a rugged structure, a granular structure, and a ladder structure.

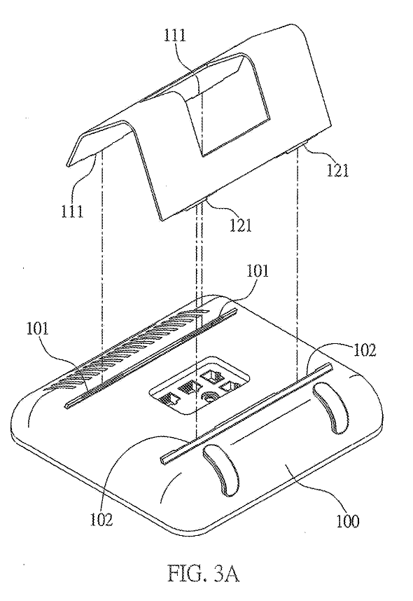

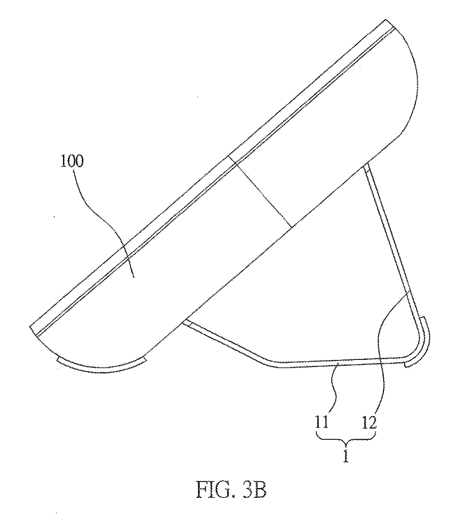

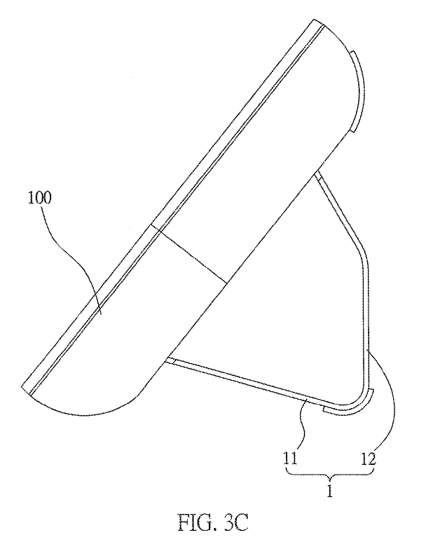

As shown in FIG. 3A, the back surface of the electronic product 100 is formed with third positional portions 101 and fourth positional portions 102, the third positional portions 101 and the fourth positional portions 102 corresponding to the first positional portions 111 and the second positional portions 121, respectively.

In the present embodiment, the third positional portions 101 and the fourth positional portions 102 have a concaved structure such as a recessed structure. Also, the structure of the third positional portions 101 and the structure of the fourth positional portions 102 can be the same such that the third positional portions 101 and the fourth positional portions 102 can be perfectly lodge in the first positional portions 111 and the second positional portions 121.

While the bracket 1 is assembled to the electronic product 100, the elastic bracket can be compressed to create a deformation for slightly shortening the distance between the two ends of the first supporting member 11 and the second supporting member 12. Once the first positional portions 111 and the second positional portions 121 have been correspondingly positioned to third positional portions 101 and the fourth positional portions 102, the compression can be released. As shown in FIG. 3B, the first positional portions 111 (hidden) and the second positional portions 121 (hidden) are lodged into the third positional portions 101 (hidden) and the fourth positional portions 102 (hidden), respectively, such that the electronic product 100 can be held on the placement surface with the bracket 1.

Further referring to FIG. 3B, since the length of the first supporting member 11 is larger than that of the second supporting member 12, the longer first supporting member 11 is roughly parallel to the placement surface and the shorter second supporting member 12 is uprightly provided on the placement surface, so as to allow the bracket 1 to hold the electronic product 100 with a smaller inclined angle with respect to the assembly structure shown in FIG. 3C described subsequently.

Moreover, the bracket of the present invention can provide different viewing angles for the electronic product 100. Because each of the first positional portions 111 has an identical structure with each of the second positional portions 121 and each of the third positional portions 101 has an identical structure as each of the fourth positional portions 102, the third positional portions 101 and the fourth positional portions 102 can, respectively, correspond to the second positional portions 121 and the first positional portions 111; i.e. the bracket member can be flipped around such that the first positional portions 111 are lodged into the fourth positional portions 102, and the second positional portions 121 are lodged in the third positional portions 101.

Therefore, as shown in FIG. 3C, the shorter first supporting member 11 is close to the placement surface and the longer second supporting member 12 is perpendicular to the placement surface, which allows the bracket 1 to hold the electronic product 100 with a larger inclined angle with respect to the assembly structure shown in FIG. 3B. In other words, the bracket can flexibly position the first positional portions 111 and the second positional portions 121 to the electronic product 100, so as to hold the electronic product at different angles on the placement surface.

The bracket 1 of the present invention differs from that of the conventional technology in that it can provide different viewing angles for the electronic product 100. And since each of the anti-slip members 14 is provided on a contacting position between the bracket 1 and the placement surface, the bracket 1 can stably hold the electronic product 100 on the placing surface. Furthermore, since the present invention is fashioned of a single plastic or metallic element formed with a simple extruding technology, the invention is able to provide a low-cost bracket.

Additionally, the bracket of the present invention only uses a simple positional structure to hold the electronic product at different viewing angles on the placement surface such that the desired viewing angles can be easily changed with the easy-assembled structure. Furthermore, the bracket of the present invention is durable due to the U-shaped structure. Moreover, the opening 13 of the bracket 1 allows the wires of the electronic product to pass thereto, so as to provide the effect of concentrating the wires easily in order to accommodate or organize them.

Although the invention is provided with a relatively large opening for concentrating the wires in the present embodiment, it is also possible to provide a plurality of openings to allow different wires to pass thereto and to separate each of the wires. In other words, the numbers, positions, and shapes of the openings are not limited by the disclosures of the present embodiment.

Therefore, the present invention is able to solve the shortcomings of the conventional bracket that provided only one viewing angle, resulting in non-optimal comfort levels under some conditions and fatigue of the user. And since the bracket of the present invention is able to provide the benefits of low-cost, easy assembly, durability, and the capability of easily concentrating wires, it is useful and increases industrial applicability of a support bracket.

### Example 2

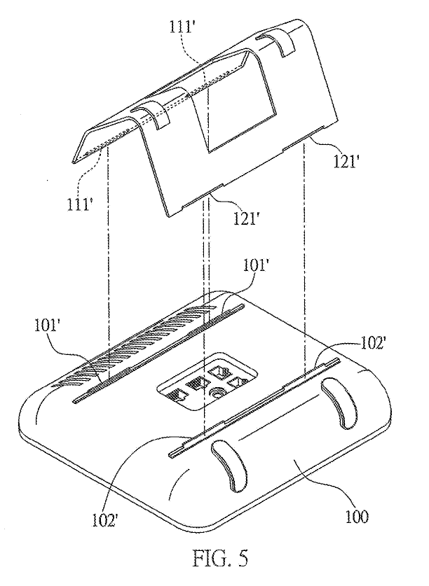

FIG. 5 is a figure of a bracket depicted in accordance with the second embodiment of the present invention, wherein, the same or similar elements are labeled with same or similar symbols as in the first embodiment and, therefore, a detailed description is omitted to simplify the present invention.

The second embodiment differs from the first embodiment in that, in the first embodiment, the first positional portions 111 and the second positional portions 121 are lodged into the fourth positional portions 102 and the third positional portions 101, while in the second embodiment, the first positional portions 111′ and the second positional portions 121′ are individually strutted by the third positional portions 101′ and the fourth positional portions 102′.

As shown in FIG. 5, the first positional portions 111′ and the second positional portions 121′ are of recessed structures, and the third positional portions 101′ and the fourth positional portions 102′ are protruding structures such as a block or a tenon joint or any other equivalent structures.

In the present embodiment, the first positional portions 111′ and the second positional portions 121′ are strutted by the third positional portions 101′ and the fourth positional portions 102′ in the corresponding recessed surfaces, which is different from the lodging mechanism of the first embodiment. However, it is also able to provide different viewing angles for the electronic product 100 by flexibly positioning the identical structures of the first positional portions 111′ and the second positional portions 121′ thereto, just as in the first embodiment.

Also, the bracket 1 can be a bracket formed with an elastic material such as plastic or metal, such that the first supporting member 11 and the second supporting member 12 can strutted on the back surface of the electronic product 100 by the elasticity of the bracket 1.

Although the first and the second embodiment set forth in the specification are explained with two symmetrically and identically provided structures of the first positional portions and the second positional portions, a person having general knowledge in the technical field will realize that the present invention could be provided with the identical structures of two of the first positional portions and one of the second positional portions, the identical structures of one of the first positional portions and two of the second positional portions, the identical structures of three of the first positional portions and two of the second positional portions, the identical structures of two of the first positional portions and three of the second positional portions, or the differing and/or asymmetrically provided structures of the first positional portions and the second positional portions could be equivalently used. That is, the structures of the first positional portions are not necessarily the same as the structures of the second positional portions, as long as the structures are capable of positioning by equivalent replacements to provide varying viewing angles. Also, the numbers, positions, and shapes of the first positional portions and the second positional portions are not limited by the disclosures of the above embodiments and adjustment of these features would be construed as equivalent variations of the present invention.

The above embodiments are merely used to exemplify the theory and utilities of the present invention, and are not used to limit the present invention. A person having general knowledge in the technical field may modify or vary the above embodiments without departing from the spirit of the present invention. Therefore, the claimed scope of the present invention should be defined in accordance with the following claims.

What is claimed is:

1. A bracket for supporting an electronic product comprising:
a first supporting member having at lease one positional portion; and
a second supporting member having at least one positional portion and connecting with and forming an included angle with the first supporting member; wherein the length of the second supporting member is larger than the first supporting member such that the bracket may hold the electronic product at a desired angle on a plane surface by flexibly positioning the one or more first positional portions and the one or more second positional portions with respect to the electronic product.

2. The bracket of claim 1, wherein the bracket is produced with an elastic material.

3. The bracket of claim 2, wherein the elastic material is a material selected from plastics and metals.

4. The bracket of claim 1, wherein the bracket has a U-shaped structure.

5. The bracket of claim 1, wherein the first supporting member and the second supporting member are part of an integral structure.

6. The bracket of claim 1, wherein each of the one or more first positional portions has a protruding structure.

7. The bracket of claim 6, wherein each of the one or more first positional portions has a structure selected from the group consisting of a jut, a bulge, and a lug structure.

8. The bracket of claim 1, wherein the included angle is an acute angle.

9. The bracket of claim 1, wherein each of the one or more second positional portions has a protruding structure.

10. The bracket of claim 9, wherein each of the one or more second positional portions has a structure selected from the group consisting of a jut, a bulge, and a lug structure.

11. The bracket of claim 1, wherein the one or more first positional portions and the one or more second positional portions have the same structure.

12. The bracket of claim 1, wherein each of the one or more first positional portions and each of the one or more second positional portions are symmetrically provided.

13. The bracket of claim 1, wherein each of the one or more first positional portions and each of the one or more second positional portions are asymmetrically provided.

14. The bracket of claim 1, wherein the second supporting member is formed with a winding structure at a position closed to the second positional portion.

15. The bracket of claim 1, further comprises an opening and a plurality of anti-slip members.

16. The bracket of claim 15, wherein the opening is provided between the first supporting member and the second supporting member.

17. The bracket of claim 15, wherein each of the anti-slip members is provided on both sides of the opening.

18. The bracket of claim 15, wherein each of the anti-slip members has a structure selected from a group consisting of a rugged structure, a granular structure, and a ladder structure.
